(19) United States
(12) Patent Application Publication
(10) Pub. No.: US 2026/0050170 A1
(43) Pub. Date: Feb. 19, 2026

(54) HEAD-WEARABLE AUGMENTED VISION APPARATUS

(71) Applicant: DODROTU LIMITED, Oxford Oxfordshire (GB)

(72) Inventors: Semen Anatoliyovych Trygubenko, Oxford Oxfordshire (GB); Tetyana Viktorivna Bogdan, Oxford Oxfordshire (GB); Sebastian Pulido Gomez, Oxford Oxfordshire (GB)

(73) Assignee: DODROTU LIMITED, Oxford Oxfordshire (GB)

(21) Appl. No.: 19/103,176

(22) PCT Filed: Aug. 10, 2023
(86) PCT No.: PCT/GB2023/052121

§ 371 Date: Feb. 11, 2025

(30) Foreign Application Priority Data
Aug. 15, 2022 (GB) 2211923.4

(51) Int. Cl. G02B 27/01; G02B 27/09

(52) U.S. Cl. CPC G02B 27/0176; G02B 27/0172; G02B 27/0955; G02B 2027/014; G02B 2027/0156

(57) ABSTRACT

A head-wearable apparatus includes a display configured to display information, a sensor configured to sense an environment outside of the apparatus, a data processing system configured to control the display using an output from the sensor, a lens system configured to allow a wearer to focus on the information displayed by the display when the apparatus is worn on a head of the wearer, and a mounting arrangement configured to allow the apparatus to be worn on the head of the wearer. The mounting arrangement includes a head engagement portion configured to fit over or around the head and a projecting portion mechanically attached to the head engagement portion and configured to extend away from the head in a generally forwards direction relative to a face of the wearer when the apparatus is worn on the head of the wearer.

### CROSS REFERENCE TO RELATED APPLICATIONS

The present application claims the priority benefits of International Patent Application No. PCT/GB2023/052121, filed on Aug. 10, 2023, and claims benefit of GB 2211923.4, filed on Aug. 15, 2022, which are hereby incorporated herein by reference in their entireties.

### FIELD OF THE INVENTION

The present disclosure relates to head-wearable augmented vision apparatus, particularly in the context of providing augmented display output for people with sensory, perceptual or cognitive disorders that affect their ability to process and interpret visual and auditory stimuli.

### BACKGROUND OF THE INVENTION

Dedicated virtual reality (VR) headsets are known but relatively expensive and heavy. Head-mountable cradles exist with optics that allow a smartphone to be held just in front of the eyes and viewed by a user. Both approaches satisfy requirements for creating a virtual reality environment but are not typically suitable for long-term wear or for use in a situation where a user needs to move around in the real world, such as might be the case for a user with some sensory, perceptual or cognitive condition who wears the device to augment awareness of the surroundings. Such devices may capture information about the environment via multiple sensors but it is difficult to convey this information to a user in a natural way. A user may have difficulty keeping balance for example relying solely on visual information provided by such displays. Furthermore, known devices are difficult to wear for long periods and can cause headache, nausea or fatigue.

It is an object of the present disclosure to at least partially address one, some or all of the shortcomings with the prior art discussed above and/or other problems.

### SUMMARY OF THE INVENTION

According to an aspect of the invention, there is provided a head-wearable apparatus, comprising: a display configured to display information; a sensor configured to sense an environment outside of the apparatus; a data processing system configured to control the display using an output from the sensor; a lens system configured to allow a wearer to focus on the information displayed by the display when the apparatus is worn on a head of the wearer; and a mounting arrangement configured to allow the apparatus to be worn on the head of the wearer, the mounting arrangement comprising: a head engagement portion configured to fit over and/or around the head; and a projecting portion mechanically attached to the head engagement portion and configured to extend away from the head in a generally forwards direction relative to the face of the wearer when the apparatus is worn on the head of the wearer, wherein the projecting portion is configured to support a weight of at least the display and the lens system.

Thus, an arrangement is provided that allows a user to view displayed information via a display that is worn by a user but while the weight of at least the display and a lens system is supported by a projecting portion that in turn is supported by a head engagement portion that fits over and/or around (e.g., encircling) the head. The head engagement portion may be, or have substantially the same form as, a hat crown, the hat crown being open or closed. The projecting portion may be, or have substantially the same form as, a hat brim, the hat brim extending only in the forwards direction or in all directions. The approach of the invention has been found to provide a significantly higher degree of comfort relative to known head-worn devices having active displays, which are typically secured to the face area of the head of the wearer via harnesses that typically apply pressure in the vicinity of eyes, ears and nose and/or to the nose, cheekbones, temples, ears and forehead, which, with prolonged use, can lead to headache, nausea or fatigue. Where it is desired to open up peripheral vision, for example by switching from a virtual reality form factor to a glasses-like form factor, the shortcomings of the prior art are made even worse because there are now typically fewer points of contact while the weight remains largely unchanged. Some use cases, such as visual aid, require the user to wear the device for many hours a day.

In an embodiment, the apparatus comprises a face contacting member supported by the projecting portion, the face contacting member configured to engage against a face of the wearer. The projecting portion may be configured to pivot under gravity to press the face contacting member against the face of the wearer and thereby provide stable positioning of the lens system relative to the face of the wearer. This approach has been found to provide a simple and effective way of ensuring correct positioning of the lens system without compromising long term wear comfort.

In an embodiment, the apparatus further comprises an abutment member configured such that, when the wearer is looking in a horizontal direction: the face contacting member extends substantially horizontally; and the abutment member extends substantially downwardly from the face contacting member and limits a range of the pivoting of the projecting portion by pressing against the face below the face contacting member. This approach has been found to allow particularly precise positioning of the lens system with minimal negative impact on long term wear comfort. This feature furthermore reduces mechanical demands on the projecting portion of the mounting arrangement, allowing for example a wider range of hat brims, including weaker hat brims, to be used to implement the projecting portion.

In an embodiment, the abutment member is configured to allow adjustment of the angle between the face of the wearer and axes of lenses of the lens system. This approach may allow the wearer to vertically control which portion of a scene is sensed by the sensor without the wearer needing to change an orientation of his/her head.

In an embodiment, the apparatus is configured such that when the face contacting member is engaged against the face the wearer has peripheral vision of the environment outside of the apparatus. Allowing peripheral vision makes it easier for a user to keep balance in comparison to alternative arrangements in which the user has to rely solely on central vision and/or where peripheral vision is blocked. Peripheral vision is important for spatial navigation (e.g., left and right monocular temporal crescents are used in spatial awareness and spatial learning).

In an embodiment, the apparatus comprises an actuatable shrouding arrangement configured to allow controllable variation of an extent of the peripheral vision. This feature provides flexibility to adapt to different use cases or scenarios and/or further improve comfort. Neither glasses-like systems (with peripheral vision uninhibited) nor VR-based system (peripheral vision fully blocked) cater optimally for all use cases: each form factor has advantages and disadvantages when it comes to specific applications. For example, glasses that ordinarily allow some use of peripheral vision for navigation could benefit from decrease of brightness of the scenes available to peripheral vision if ambient light is too strong. VR-based systems could benefit from “opening up” to both let peripheral vision be used in navigation like with glasses but also so that more of the face of the wearer is exposed to the person the wearer is interacting with (or to a front facing camera if interacting remotely), allowing to better capture facial expressions and emotions.

These and other objects, advantages and features of the invention will become apparent upon review of the following specification in conjunction with the drawings.

### BRIEF DESCRIPTION OF THE DRAWINGS

Embodiments of the disclosure will now be further described, merely by way of example, with reference to the accompanying drawings.

FIG. 1 is a perspective view of a head-wearable apparatus from below;

FIG. 2 is a perspective front view of a portion of the apparatus of FIG. 1 showing details of an example smartphone holder;

FIG. 3 is a perspective rear view of a portion of an apparatus showing a shrouding arrangement having L-shaped members in a blocking state;

FIG. 4 is a perspective view of the arrangement of FIG. 3 from below;

FIG. 5 is a perspective view of the arrangement of FIG. 3 from below with the L-shaped members of the shrouding arrangement in an open state;

FIGS. 6 and 7 are perspective views from below of a portion of an apparatus having lens housings configured to be switchable between an axially extended state and an axially contracted state; FIG. 6 depicts the lens housings in the axially extended state;

FIG. 7 depicts the lens housings in an intermediate state between the axially extended and axially contracted states;

FIGS. 8-10 are side views of the arrangement of FIGS. 6 and 7 with the lens housings in the axially contracted state and a pivotable support member in three different stages of transition between a deployed position and a storage position; and

FIGS. 11 and 12 are perspective views of alternative configurations for the mounting arrangement of the apparatus.

### DESCRIPTION OF THE PREFERRED EMBODIMENTS

The present disclosure relates to a head-wearable apparatus. Example arrangements are discussed below.

The apparatus comprises a display, a sensor, and a data processing system.

The display is configured to display information. The display may comprise an electronic display for example. The display may be opaque or transparent.

The sensor is configured to sense an environment outside of the apparatus. For example, the sensor may be configured to perform one or more of the following in any combination: capture visual scenes; record audio data; acquire multi-point distance information across a field-of-view, optionally by performing light detection and ranging, LiDaR; measure linear acceleration; measure intensity of ambient light; measure magnetic field or magnetic dipole moment; and measure angular velocity.

The data processing system is configured to control the display using an output from the sensor. Any of various known configurations may be provided for providing the required data processing functionality (e.g., including CPUs, GPUs, memory, power, etc.). For example, the data processing system may be configured such that the control of the display using the output from the sensor comprises one or more of the following in any combination: segmentation and matting; localization and mapping; enhancement of colour; adjustment of brightness; adjustment of contrast; tracking of objects; estimation of poses; recognition and/or parsing of textual information; recognition of objects and/or attributes of objects; measurement of distance to objects; location of objects and boundaries of objects; estimation of a change in position; detection of obstacles; parsing of spoken language and/or translation; and detection of faces, emotions and/or actions of people.

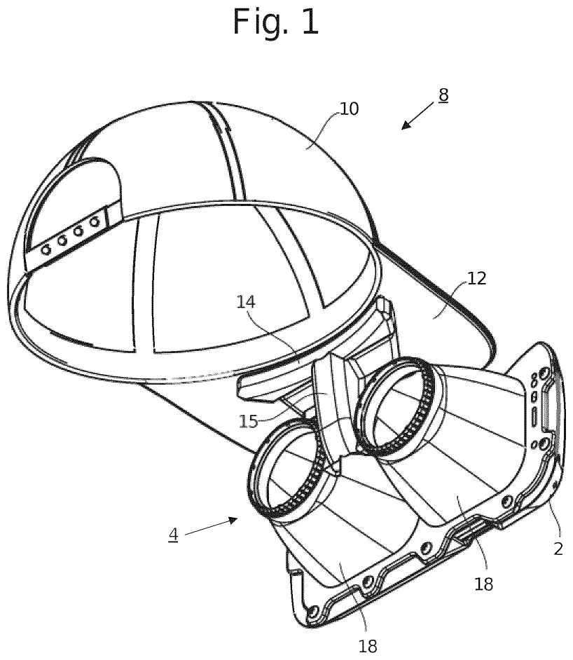

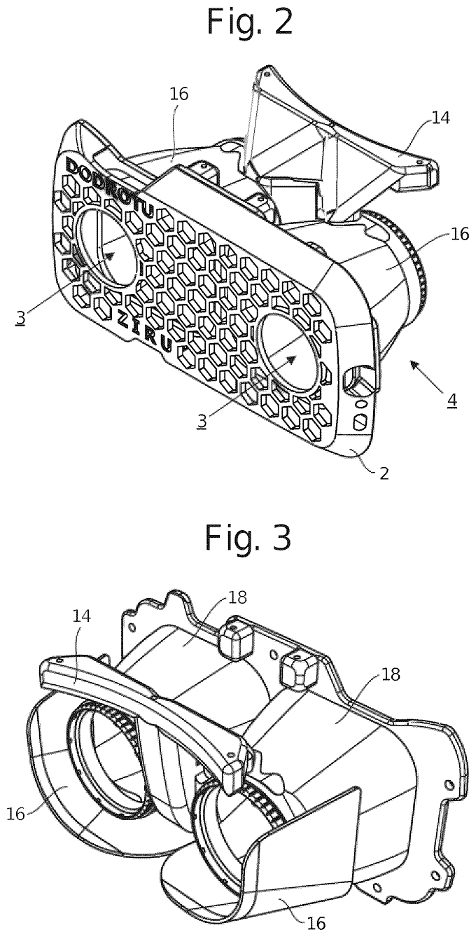

The display, sensor and data processing system may be provided by a portable computing apparatus such as a smartphone. Arrangements of this type are exemplified in the figures. Referring to FIGS. 1 and 2, for example, the apparatus may comprise a smartphone holder 2 and a smartphone supported by the smartphone holder.

The smartphone holder 2 is configured to hold the smartphone. As depicted in FIG. 2, the smartphone holder 2 may, for example, comprise a cage defining an internal volume into which a smartphone may be placed and held securely. FIG. 2 shows the cage in a closed state without a smartphone in place. The cage may be opened by a user and a smartphone placed inside. Any of various known techniques may be used to allow a range of different sizes and shapes of smartphone to be held appropriately in the internal volume, including specially dimensioned adaptors and/or resilient members. The smartphone holder 2 defines at least one opening 3 or transparent portion configured to allow a camera (an example of a sensor) of the smartphone to be able to capture images outside of the smartphone holder 2 when the smartphone is held in the smartphone holder 2. Images may, for example, be captured of a region in front of the smartphone holder 2 (on the opposite side of the smartphone holder from the wearer) and/or of a region behind the smartphone holder 2 (e.g., of the wearer himself/herself, for example to capture emotions etc. of the wearer).

The apparatus further comprises a lens system 4, and a mounting arrangement comprising a head engagement portion 10 and a projecting portion 12. The lens system 4 is configured to allow a wearer of the apparatus to focus on the information displayed by the display (e.g., to focus on the display of a smartphone held in the smartphone holder 2) when the apparatus is worn on the head of the wearer. Lens systems configured to allowing focusing on objects closer to the eye than would be possible without lenses are well known and any suitable configuration of lenses may be used. Lenses for each eye may be provided in respective lens housings 18. Lenses of the lens system 4 will typically be separate from the display but this is not essential. The display could be partly or entirely integrated (e.g., embedded) into one or more lenses of the lens system 4.

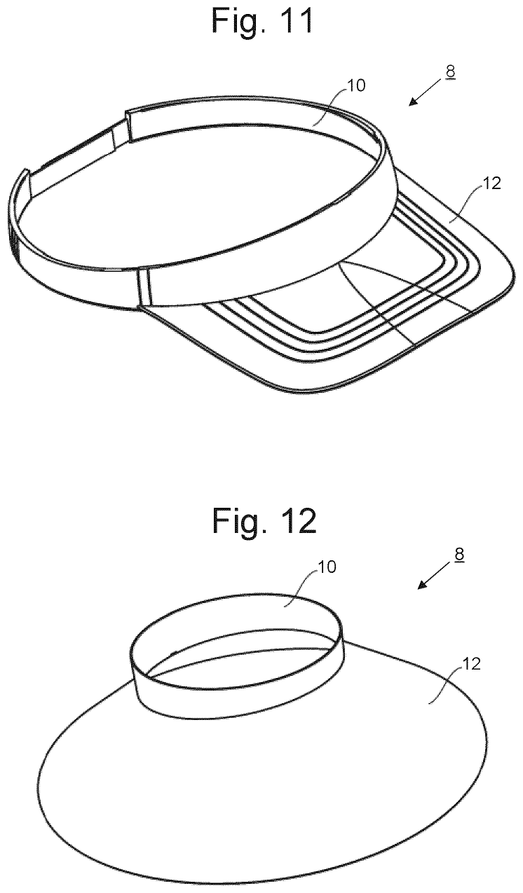

The mounting arrangement formed by the head engagement portion 10 and the projecting portion 12 allow the apparatus to be worn on the head. The engagement portion 10 is configured to fit over and/or around (e.g., encircling) the head in such a way that the projecting portion 12, which is mechanically attached to the head engagement portion 10, can support the weight of at least the display and the lens system, optionally also the sensor and data processing system, without the head engagement portion disengaging from or shifting significantly on the head. In arrangements comprising a smartphone held in a smartphone holder 2, the projecting portion 12 is configured to be able to support the smartphone, the smartphone holder 2, and the lens system 4 without the head engagement portion disengaging from or shifting significantly on the head. The engagement portion 10 may have substantially the same form as the crown of a hat (a hat crown). The hat crown may be closed, as in the example of FIG. 1. In other arrangements, the hat crown may be open. An example of a mounting arrangement having a head engagement portion in the form of an open hat crown is shown in FIG. 11.

The projecting portion 12 is mechanically attached to the head engagement portion 10 and configured to extend away from the head in a generally forwards direction relative to the face of the wearer when the apparatus is worn on the head of the wearer. The projecting portion 12 may have substantially the same form as the brim of a hat (a hat brim). The hat brim may extend in the forwards direction only, as in the example of Figure I. In other arrangements, the hat brim may extend in all directions. An example of a mounting arrangement having a projecting portion 12 in the form of a hat brim extending in all directions is shown in FIG. 12.

The display, sensor, data processing system and lens system may be provided in a unit connected to the projecting portion 12. The unit may be detachably connected to the projecting portion 12.

In some arrangements, the apparatus comprises a face contacting member 14. The face contacting member 14 may be supported by the projecting portion 12 of the mounting arrangement. The face contacting member 14 is configured to engage against a face of the wearer, typically against an upper portion of the face such as the forehead. The projecting portion 12 is configured to pivot under gravity to press the face contacting member 14 against the face of the wearer and thereby provide stable positioning of the lens system 4 relative to the face of the wearer. Thus, the weight of the display and the lens system (and, optionally, the sensor and data processing system, such as when these elements are provided by a smartphone in a smartphone holder 2) may apply a torque to the projecting portion 12 that causes it to bend downwards (e.g., to pivot about an axis in the vicinity of where the projecting portion 12 connects to the head engagement portion 10) until the face contacting member 14 presses against the face with sufficient force to balance the torque. This arrangement ensures that the apparatus can be quickly and reliably mounted in such a way that the lens system 4 is positioned appropriately in front of the wearer's eyes with no or a minimum of time-consuming adjustments needing to be made by the wearer (e.g., to align the lens system and/or adjust focusing of the lenses). It has been found that this functionality can be achieved particularly effectively by arranging for the face contacting member 14 to contact the face along an elongate path conforming with the head of the wearer. The face contacting member 14 may in particular be configured such that the elongate path has an axis of elongation lying substantially in a horizontal plane when the apparatus is worn on the head of the wearer and the wearer is looking in a horizontal direction, as exemplified in FIG. 1 for example.

In some arrangements, the face contacting member 14 is arranged to extend substantially horizontally when a wearer is looking in the horizonal direction and the apparatus further comprises an abutment member 15 extending substantially downwardly from the face contacting member 14 and configured to limit a range of pivoting of the projecting portion 12 under the weight of elements attached to the projecting portion (e.g., smartphone holder 2, smartphone, and lens system 4). The pivoting is limited by the abutment member 15 exerting pressure (i.e., pressing) against the face at a position below the face contacting member 14. The abutment member 15 thus helps to reliably fix the position and alignment of the lens system 4 relative to the eyes of the wearer. In some arrangements, the abutment member 15 is configured to allow adjustment of the angle between the face of the wearer and axes of lenses of the lens system 4. The abutment member 15 can thereby precisely control the angle between the face of the wearer and the projecting portion 12, allowing the user to better control which part of the scene is being captured by the device (e.g., sensed by the sensor) without changing an orientation of the head. In some arrangements, the abutment member 15 is configured to substantially conform with the external shape of bone structure between the eyes of the wearer. The abutment member 15 may be connected to and/or supported by the face contacting member 14 and/or the projecting portion 12 of the mounting arrangement.

In some arrangements, the apparatus is configured such that when the face contacting member 14 is engaged against the face the wearer has peripheral vision of the environment outside the apparatus. The apparatus thus fits on the wearer in such a way as to allow a degree of peripheral vision. Allowing peripheral vision improves comfort for a wearer, particularly where the apparatus is configured to provide support for a visually impaired person interacting with the environment, for example by augmenting vision as the wearer moves through and/or interacts with the environment. The smartphone may, for example, be configured to capture visual information using a camera of the smartphone and display a processed version of the captured visual information on a display of the smartphone. The processed version of the captured visual information may be configured to be more easily interpretable by the visually impaired wearer than the captured visual information. Allowing peripheral vision in this context may make it easier for the wearer to maintain balance, thereby enhancing safety.

The data processing system may be configured to augment information displayed by the display in a variety of different ways. These may include one or more of the following:
captured images can be subject to colour enhancement, e.g. through adjustment of the contrast based on the lighting conditions of a scene;
captured images can be subject to edge enhancement by detecting the edges in a scene and highlighting them in a way that facilitates their identification by the user;
captured images can be subject to object recognition, that is, specific objects in a scene are detected and the nature and attributes of those objects are conveyed to the user via some output mechanism;
captured images can be subject to motion tracking of relevant objects, that is, the direction in which a specific object in a scene moves is highlighted in a way that makes it easier to identify this motion; motion tracking together with object recognition can be used for obstacle avoidance by conveying information about an obstacle and its potential direction to the user;
captured textual information present in images can be subject to optical character recognition in order to help the user understand the content of a block of text;
captured images can be subject to stabilization, that is, in case that the user's head is unstable or shaking, the captured frames are stabilized to compensate for the head motion and present a more stable and more consistent scene to the user;
the distance measure module can provide information about the distance to different objects; this together with object recognition can help the user have an estimation of the distance to an object of interest or can help them identify the distance to a specific obstacle;
audio data can be captured via the device's microphones; this data can be used to parse human spoken language and trigger actions based on the processed input; directional information in audio stream can be extracted, combined with inputs from other sensors and assist in spatial cognition and spatial awareness.

The peripheral vision may be allowed in all peripheral directions or in a selected subset of the available directions. In some implementations, peripheral vision may be allowed in lateral directions and/or in a downwards direction. Peripheral vision in the upwards direction maybe blocked by the projecting portion 12 of the mounting arrangement.

In some arrangements, a degree to which peripheral vision is allowed may be controlled by the wearer and/or by the data processing system. The apparatus may thus be switchable between different modes. In some situations, for example, it may be desirable to completely block peripheral vision and allow a wearer to focus entirely on an output from the display. This may be appropriate where the wearer is sat down or otherwise physically inactive. Alternatively, the surrounding environment may be excessively bright or otherwise distracting, such that it would be more comfortable to suppress peripheral vision. In other situations, for example where the wearer is interacting more actively with the surroundings and/or moving about, it may be desirable to switch the apparatus to a mode allowing peripheral vision or allowing peripheral vision to a greater extent. These operations may be performed manually by the wearer or automatically by the data processing system. For example, the data processing system may detect when the wearer switches from an inactive state to an active state using a motion sensor (e.g., accelerometer) and respond by increasing peripheral vision. Alternatively or additionally, the data processing system may detect changes in the intensity of ambient light and respond by modifying the peripheral vision (reducing peripheral vision when an increase in intensity is detected, such as when the sun comes out, and increasing peripheral vision when a decrease in intensity is detected). The apparatus can thus automatically seek to provide an optimal balance between light from the display and ambient light entering via peripheral vision.

In some arrangements, the apparatus comprises an actuatable shrouding arrangement configured to allow controllable variation of an extent of the peripheral vision. The variation may be controlled by the data processing system, by the wearer, or may happen automatically for other reasons (e.g., via materials that respond to different intensities of ambient light). The variation may be achieved at least partly by varying a transparency (e.g., transmittance) of a material of variable transparency. The shrouding arrangement may thus comprise a material having variable transparency. Alternatively, or additionally, as exemplified in FIGS. 3 to 5, the variation may be achieved mechanically (by movement and/or rotation of one of more elements).

FIGS. 3 to 5 depict an example of a class of arrangement in which the apparatus can control peripheral vision using an actuatable shrouding arrangement 16. For ease of illustration, the smartphone holder 2 is not shown in FIGS. 3-5. The shrouding arrangement 16 may be actuated manually via direct manual manipulation from the wearer. Alternatively, the shrouding arrangement 16 may be actuated electrically, for example via a motor or any other suitable powered mechanism. Such actuation may be controlled by the data processing system, for example in response to output from the sensor. The actuatable shrouding arrangement 16 is configured to allow the shrouding arrangement 16 to be selectively switched between an open state and one or more peripheral vision inhibiting states. In the particular example shown, the shrouding arrangement 16 comprises L-shaped members, one for each eye, that block peripheral vision laterally and in a downwards direction. Various other arrangements are possible.

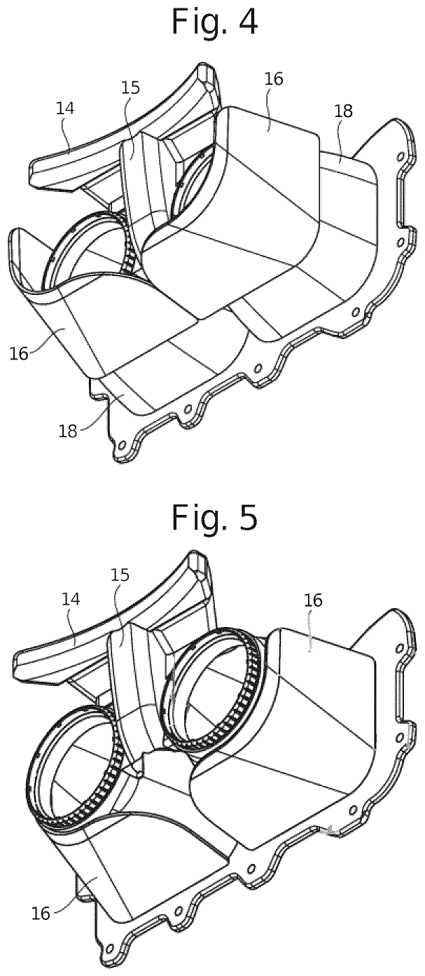

The or each peripheral vision inhibiting state of the shrouding arrangement 16, exemplified in FIGS. 3 and 4, is such that when the face contacting member 14 is engaged against the face of the user the user is able to focus on the information displayed by the display and the shrouding arrangement 16 inhibits peripheral viewing of the surrounding environment relative to the open state.

The open state of the shrouding arrangement 16, exemplified in FIG. 5, is such that when the face contacting member 14 is engaged against the face of the wearer the wearer can focus on the information displayed by the display and peripherally view a portion of the environment.

The one or more peripheral vision inhibiting states may comprise a plurality of peripheral vision inhibiting states, with each peripheral vision inhibiting state inhibiting peripheral vision to a different extent. In the arrangement of FIGS. 3 to 5, for example, the shrouding arrangement 16 is actuatable to position the L-shaped members at a plurality of different positions along a longitudinal displacement axis parallel to optical axes of the lens system 4. Different peripheral vision inhibiting states may be provided by allowing the L-shaped members to be positionable at one or more positions that are intermediate between a fully blocking state (e.g., as shown in FIGS. 3 and 4) where peripheral vision is completely blocked and a fully open state where the L-shaped members do not inhibit peripheral vision at all. At such intermediate positions the shrouding arrangement 16 may reduce peripheral vision but does not block peripheral vision completely. Providing such a plurality of peripheral vision inhibiting states provides enhanced control for the wearer. For example, the wearer could adapt the degree of blocking of peripheral vision as a function of a brightness of the surrounding environment, e.g., to provide a higher level of blocking when the wearer is outside, particularly in sunny weather, and a lower level of blocking when the wearer is inside or where the weather is overcast or when the sun is not at a high level in the sky etc.

The shrouding arrangement 16 may be configured in a range of different ways to achieve the desired functionality. In some arrangements, at least a portion of the shrouding arrangement 16 is configured to move and/or rotate so as to be positioned closer to the face of the wearer in the one or more peripheral vision inhibiting states than in the open state. As described above, in the example of FIGS. 3-5, L-shaped members of the shrouding arrangement 16 move longitudinally. In an alternative arrangement, the shrouding arrangement 16 may comprise a hinged shrouding element that is rotatable about an axis of the hinge from a blocking position to an open position. Alternatively or additionally, the shrouding arrangement may comprise a plurality of pins that are individually moveable along mutually parallel pin axes. Each pin blocks a portion of the peripheral vision when in a longitudinally advanced position. By selectively advancing available pins it is possible to vary the extent and directionality of peripheral vision blocking in a highly flexible manner Alternatively or additionally, the shrouding arrangement can be installed in a permanently closed state but made from material of variable transparency, with the level of transparency being controlled by the data processing system based on the use case (e.g., viewing photos vs navigating environment) or based on sensor input (e.g., amount of light as read by ambient light sensor).

In some arrangements the lens system 4 comprises two tubular lens housings 18. Each lens housing 18 contains one or more of the lenses of the lens system 4 and is aligned such that the wearer can look axially through the lens housing 18, and through the lenses contained by the lens housing 18, with a respective eye. Thus, a left eye would look through one of the lens housings 18 and the right eye would look through the other one. In the open state of the shrouding arrangement 16, as exemplified in FIG. 5, the shrouding arrangement 16 is positioned at a same distance, or further (as shown in FIG. 5), from the face of the wearer than each lens housing 18. In the or each peripheral vision inhibiting state, as exemplified in FIGS. 3 and 4, the shrouding arrangement 16 is positioned closer to the face of the wearer than each tubular lens housing 18.

In some arrangements, the lens system 4 is configured to be switchable between a viewing mode and a storage mode. The viewing mode is such that the lens system 4 is in a directly forwards line of sight of the wearer of the apparatus. The storage mode is such that the lens system 4 is outside of the directly forwards line of sight of the wearer of the apparatus, optionally with lenses of the lens system 4 folded towards the projecting portion 12 of the mounting arrangement, optionally so as to be parallel and/or flush with (e.g., directly adjacent to) the projecting portion 12 of the mounting arrangement.

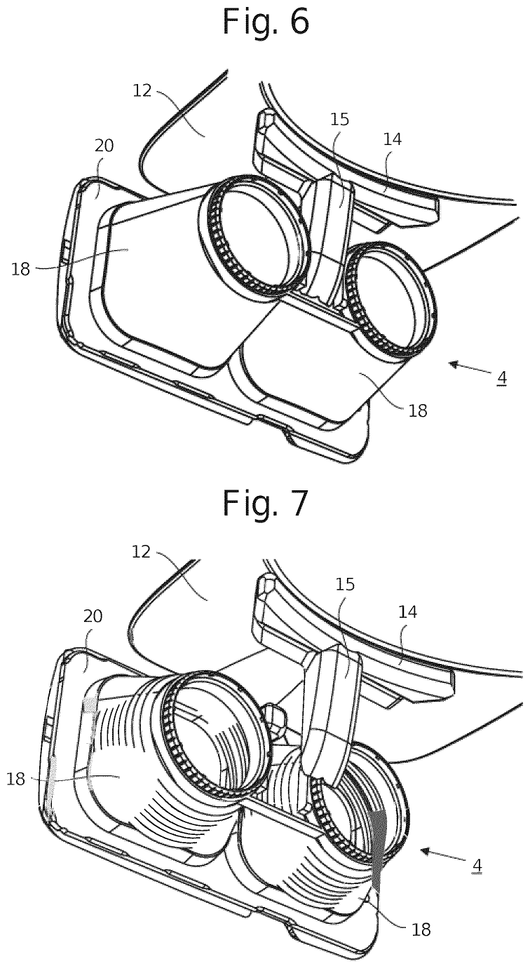

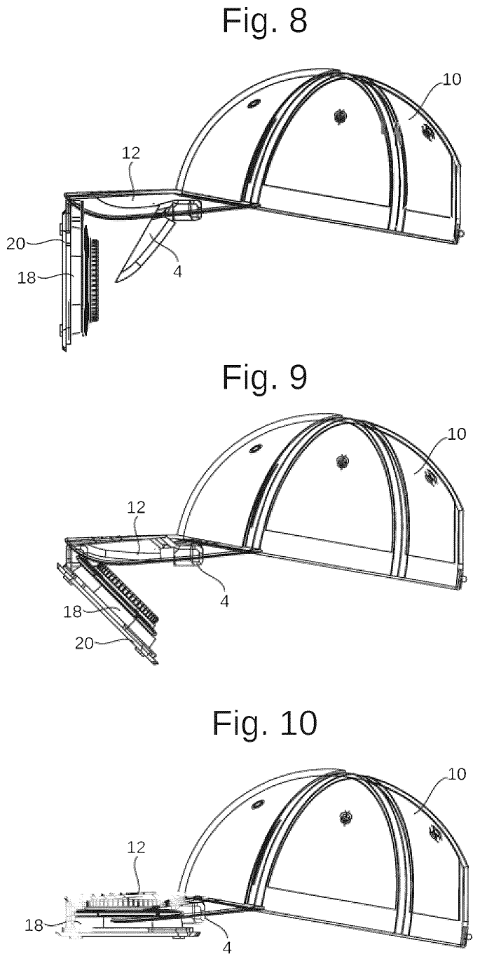

In some arrangements, as exemplified in FIGS. 6-10, the switching between the viewing mode and the storage mode may be facilitated by arranging for the lens housings 18 to be switchable between an axially extended state (shown in FIG. 6) and an axially contracted state (shown in FIGS. 7-10). This may be achieved by providing the lens housings 18 with walls formed from a malleable/deformable material or by configuring the walls to be compressible longitudinally in the manner of a bellows or concertina. This allows an overall thickness of the lens system 4, in a direction parallel to the optical axes, to be reduced when required. The reduction in thickness facilitates folding away of the lens system 4, for example when the wearer does not wish to use the apparatus. As depicted in FIGS. 8-10, the apparatus may comprise a pivotable support member 20 that allows the lens housings 18 (and smartphone holder 2 in the arrangement shown) to be pivoted to the storage position when the lens housings 18 are in the axially contracted state.

Changes and modifications in the specifically-described embodiments may be carried out without departing from the principles of the present invention, which is intended to be limited only by the scope of the appended claims as interpreted according to the principles of patent law including the doctrine of equivalents.

1. A head-wearable apparatus, comprising:
a display configured to display information;
a sensor configured to sense an environment outside of the apparatus;
a data processing system configured to control the display using an output from the sensor;
a lens system configured to allow a wearer to focus on the information displayed by the display when the apparatus is worn on a head of the wearer; and
a mounting arrangement configured to allow the apparatus to be worn on the head of the wearer, the mounting arrangement comprising:
a head engagement portion configured to fit over or around the head; and
a projecting portion mechanically attached to the head engagement portion and configured to extend away from the head in a generally forwards direction relative to a face of the wearer when the apparatus is worn on the head of the wearer, wherein the projecting portion is configured to support a weight of at least the display and the lens system.

2. The apparatus of claim 1, wherein the projecting portion has a form that is substantially similar to a hat brim, the projecting portion extending only in the forwards direction or in all directions, and wherein the head engagement portion has a form that is substantially similar to a hat crown, the head engagement portion being open or closed.

3. (canceled)

4. The apparatus of claim 1, wherein the display, sensor, data processing system and lens system are provided in a unit connected to the projecting portion.

5. The apparatus of claim 1 further comprising a smartphone holder and a smartphone supported by the smartphone holder, wherein the smartphone comprises the display, sensor, and data processing system, and the smartphone holder is supported by the projecting portion.

6. The apparatus of claim 1, wherein the lens system is configured to be switchable between a viewing mode and a storage mode, the viewing mode being such that the lens system is in a directly forwards line of sight of the wearer of the apparatus and the storage mode being such that the lens system is outside of the directly forwards line of sight of the wearer of the apparatus; and
wherein one or more lenses of the lens system are folded towards the projecting portion of the mounting arrangement so as to be parallel or flush with the projecting portion of the mounting arrangement.

7. The apparatus of claim 1 further comprising a face contacting member supported by the projecting portion, the face contacting member configured to engage against the face of the wearer, wherein the projecting portion is configured to pivot under gravity to press the face contacting member against the face of the wearer and thereby provide stable positioning of the lens system relative to the face of the wearer.

8. (canceled)

9. The apparatus of claim 7, wherein the apparatus further comprises an abutment member configured such that, when the wearer is looking in a horizontal direction:
the face contacting member extends substantially horizontally; and
the abutment member extends substantially downwardly from the face contacting member and limits a range of the pivoting of the projecting portion by pressing against the face below the face contacting member;
wherein the abutment member is configured to allow adjustment of the angle between the face of the wearer and axes of lenses of the lens system, thereby allowing the wearer to vertically control which portion of a scene is sensed by the sensor without the wearer changing an orientation of the head.

10. The apparatus of claim 7, wherein the face contacting member is configured to contact the face along an elongate path conforming with the head of the wearer.

11. The apparatus of claim 10, wherein the face contacting member is configured such that the elongate path has an axis of elongation lying substantially in a horizontal plane when the apparatus is worn on the head of the wearer and the wearer is looking straight ahead in a horizontal direction.

12. The apparatus of claim 7 further comprising an actuatable shrouding arrangement and configured such that, when the face contacting member is engaged against the face, the wearer has peripheral vision of the environment outside of the apparatus, wherein the actuatable shrouding arrangement is configured to allow controllable variation of an extent of the peripheral vision.

13. (canceled)

14. The apparatus of claim 7 further comprising:
an actuatable shrouding arrangement configured to allow the shrouding arrangement to be selectively switched between an open state and one or more peripheral vision inhibiting states;
wherein the open state is such that, when the face contacting member is engaged against the face of the wearer, the wearer can focus on the information displayed by the display and peripherally view a portion of the environment; and
wherein each peripheral vision inhibiting state is such that, when the face contacting member is engaged against the face of the user, the user is able to focus on the information displayed on the display and the shrouding arrangement inhibits peripheral viewing of the environment relative to the open state.

15. The apparatus of claim 14, wherein the one or more peripheral vision inhibiting states comprise a plurality of peripheral vision inhibiting states, each peripheral vision inhibiting state being such as to inhibit peripheral vision to a different extent.

16. The apparatus of claim 14, wherein at least a portion of the shrouding arrangement is configured to move or rotate so as to be positioned closer to the face of the wearer in the one or more peripheral vision inhibiting states than in the open state.

17. The apparatus of claim 14, wherein the lens system comprises two tubular lens housings, each lens housing containing one or more of the lenses of the lens system and being aligned such that the wearer can look axially through the lens housing, and through the lenses contained by the lens housing, with a respective eye.

18. The apparatus of claim 17, wherein when the shrouding arrangement is in the open state the shrouding arrangement is positioned at a distance that is equal or greater from the face of the wearer than each lens housing; and
wherein when the shrouding arrangement is in the peripheral vision inhibiting state, the shrouding arrangement is positioned closer to the face of the wearer than each lens housing.

19. The apparatus of claim 1, wherein the lens system comprises two tubular lens housings, each lens housing containing one or more of the lenses of the lens system and being aligned such that the wearer can look axially through the lens housing, and through the lenses contained by the lens housing, with a respective eye, and wherein each lens housing is configured to be switchable between an axially extended state and an axially contracted state.

20. (canceled)

21. The apparatus of claim 19, wherein the lens housings are supported by a pivotable support member configured to allow the lens housings to be pivoted to a storage position outside of a directly forwards line of sight of the wearer of the apparatus, when the lens housings are in the axially contracted state, the storage position optionally being such that the pivotable support member and/or lens housings are substantially parallel and/or flush with the projecting portion of the mounting arrangement.

22. The apparatus of claim 12, wherein the data processing system is configured to control actuation of the shrouding arrangement in response to the output from the sensor, and wherein the shrouding arrangement is configured to be at least partly actuated manually by the wearer.

23. (canceled)

24. The apparatus of claim 1, wherein the sensor is configured to perform one or more of the following in any combination:
capture visual scenes;
record audio data;
acquire multi-point distance information across a field-of-view by performing light detection and ranging (LiDaR);
measure linear acceleration;
measure intensity of ambient light;
measure magnetic field or magnetic dipole moment; and
measure angular velocity.

25. The apparatus of claim 1, wherein the data processing system is configured such that the control of the display using the output from the sensor comprises one or more of the following in any combination:
segmentation and matting;
localization and mapping;
enhancement of colour;
adjustment of brightness;
adjustment of contrast;
tracking of objects;
estimation of poses;
recognition and/or parsing of textual information;
recognition of objects and/or attributes of objects;
measurement of distance to objects;
location of objects and boundaries of objects;
estimation of a change in position;
detection of obstacles;
parsing of spoken language and/or translation; and
detection of faces, emotions and/or actions of people.
